(19) United States
(12) Patent Application Publication
(10) Pub. No.: US 2003/0135313 A1
(43) Pub. Date: Jul. 17, 2003

(54) Configuration and method for switching off at least one stationary-vehicle current apparatus

(76) Inventors: Rolf Bruck, Bergisch Gladbach (DE); Joachim Grosse, Erlangen (DE); Jorg-Roman Konieczny, Siegburg (DE); Meike Reizig, Bonn (DE)

Correspondence Address: LERNER AND GREENBERG, P.A., Post Office Box 2480, Hollywood, FL, 33022-2480, US

(21) Appl. No.: 10/329,972

(22) Filed: Dec. 26, 2002

Related U.S. Application Data
(63) Continuation of application No. PCT/DE01/02304, filed on Jun. 22, 2001.

(30) Foreign Application Priority Data
Jun. 26, 2000 (DE) 100 31 061.3

(51) Int. Cl. F02D 13/04; B62K 5/02

(52) U.S. Cl. 701/36; 123/322; 180/216; 180/279; 180/60; 307/10.1

(57) ABSTRACT

The invention relates to a configuration and to a method for disconnecting at least one fixed electric device such as a fixed electric consumer or a fixed electric generator in a motor vehicle. Fixed electric generators, in particular, require fuel. The invention enables the operator of a motor vehicle to be protected against an unpleasant surprise caused by a running fixed electric device that empties the tank. A device for disconnecting fixed electric devices is connected to a measuring device for determining the contents of the tank.

### CROSS-REFERENCE TO RELATED APPLICATION

This application is a continuation of copending International Application No. PCT/DE01/02304, filed Jun. 22, 2001, which designated the United States and was not published in English.

### BACKGROUND OF THE INVENTION

Field of the Invention

The invention relates to a configuration for switching off at least one stationary-vehicle current apparatus. In addition, the invention also relates to a method for switching off such a stationary-vehicle current apparatus, in particular when applied in a motor vehicle.

Published German Patent Application DE 195 23 109 A1 discloses a current-generating system for a vehicle with an internal combustion engine, in which system there is a fuel cell system instead of a dynamo. The fuel cell system is supplied by the liquid motor vehicle fuel from which hydrogen is obtained. The remaining fuel components are either burned or fed back to the fuel tank as a liquid condensate. The fuel cell system which is described in the document can advantageously be used to operate current loads independently of a dynamo, i.e. in particular even when the engine is stationary. The term used is therefore “stationary-vehicle current apparatus”.

Generally known stationary-vehicle current apparatuses, for example, in a vehicle—are, on the one hand, stationary-vehicle current loads such as an air-conditioning system, heater, icebox, etc. and, on the other hand, stationary-vehicle current generators such as a battery, a storage cylinder or a fuel cell module. Stationary-vehicle current generators specifically require reaction gases or chemical reactants and thus consume fuel—when they are in operation—even when the vehicle is in a state of rest.

This results in two problems including a first problem in which the apparatus can unintentionally run, for example, for a weekend. A second problem is, for example, when the tank is empty and the vehicle is no longer operative as a result of one or more stationary-vehicle current apparatuses operating for too long, albeit intentionally.

### SUMMARY OF THE INVENTION

It is accordingly an object of the invention to provide a configuration and a method for switching off at least one stationary-vehicle current apparatus, which overcome the above-mentioned disadvantages of the prior art configurations and methods of this general type.

In particular, it is an object of the invention to provide a configuration and a method with which undesired fuel consumption by stationary-vehicle current apparatuses is restricted at least in such a way that the apparatuses are switched off at a predefined minimum filling level of the tank.

The subject matter of the invention is a configuration for switching off at least one stationary-vehicle current apparatus which is connected to a measuring device for determining the contents of the tank in such a way that the information relating to the contents of the tank automatically activate the switching-off device when a predefinable value is reached. Furthermore, the subject matter of the invention is a method for switching off at least one stationary-vehicle current apparatus in which a controller is provided which switches off at least one stationary-vehicle apparatus as a function of the contents of the tank.

According to one advantageous embodiment, the device for switching off the stationary-vehicle current apparatus has an optical, acoustic, olefactory and/or other display with which a running or activated stationary-vehicle current apparatus is indicated to the operator of the vehicle before he leaves the vehicle—that is to say if appropriate, before the vehicle doors are locked.

With the foregoing and other objects in view there is provided, in accordance with the invention, a configuration including: a tank for storing fuel; at least one stationary-vehicle current apparatus directly or indirectly requiring the fuel from the tank; a switching device for switching off the stationary-vehicle current apparatus; and a measuring device for determining an amount of the fuel in the tank. The switching device is automatically activated by information relating to the amount of the fuel in the tank when a predefined value is reached.

In accordance with an added feature of the invention, the stationary-vehicle current apparatus is a stationary-vehicle current generator or a stationary-vehicle current load.

In accordance with an additional feature of the invention, the stationary-vehicle current apparatus is a fuel cell system and/or a fuel cell module with or without a reformer.

In accordance with another feature of the invention, the configuration includes a device for indicating, to an operator of a vehicle—before the operator leaves the vehicle—that the stationary-vehicle current apparatus is running and/or activated. The device can be an optical indicating mechanism, an acoustic indicating mechanism, and/or an olefactory indicating mechanism or another type of display.

In accordance with a further feature of the invention, the device includes a communications network.

In accordance with a further added feature of the invention, the configuration includes a display for indicating, to an operator of a vehicle—before the operator leaves the vehicle—that the stationary-vehicle current apparatus is running and/or activated.

In accordance with a further additional feature of the invention, the predefined value is between 2 and 20% of the amount of the fuel in the tank.

In accordance with another added feature of the invention, the predefined value is between 5 and 15% of the amount of the fuel in the tank.

In accordance with another additional feature of the invention, the tank is a storage cylinder.

With the foregoing and other objects in view there is provided, in accordance with the invention, a method for switching off at least one stationary-vehicle current apparatus. The method includes providing a device for switching off the stationary-vehicle current apparatus as a function of contents of a tank.

In accordance with an added mode of the invention, the method includes informing a predefined entity before performing a switching-off operation with the device.

In accordance with an additional mode of the invention, the method includes performing the step of switching off the stationary-vehicle current apparatus in a plurality of steps; and finally switching off a stationary-vehicle and/or an onboard power supply while preserving emergency functions.

In accordance with another mode of the invention, the method includes performing the step of switching off the stationary-vehicle current apparatus after making an inquiry to a predefined entity.

In accordance with a further mode of the invention, the predefined entity is a driver and/or a keeper of the vehicle.

Other features which are considered as characteristic for the invention are set forth in the appended claims.

Although the invention is illustrated and described herein as embodied in a device and method for switching off at least one stationary-vehicle current apparatus, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic diagram of a motor vehicle having stationary-vehicle current apparatus; and

FIG. 2 is a schematic diagram of a device for switching off a stationary-vehicle current apparatus, which device can be used in the motor vehicle shown in FIG. 1.

### DESCRIPTION OF THE PREFERRED EMBODIMENTS

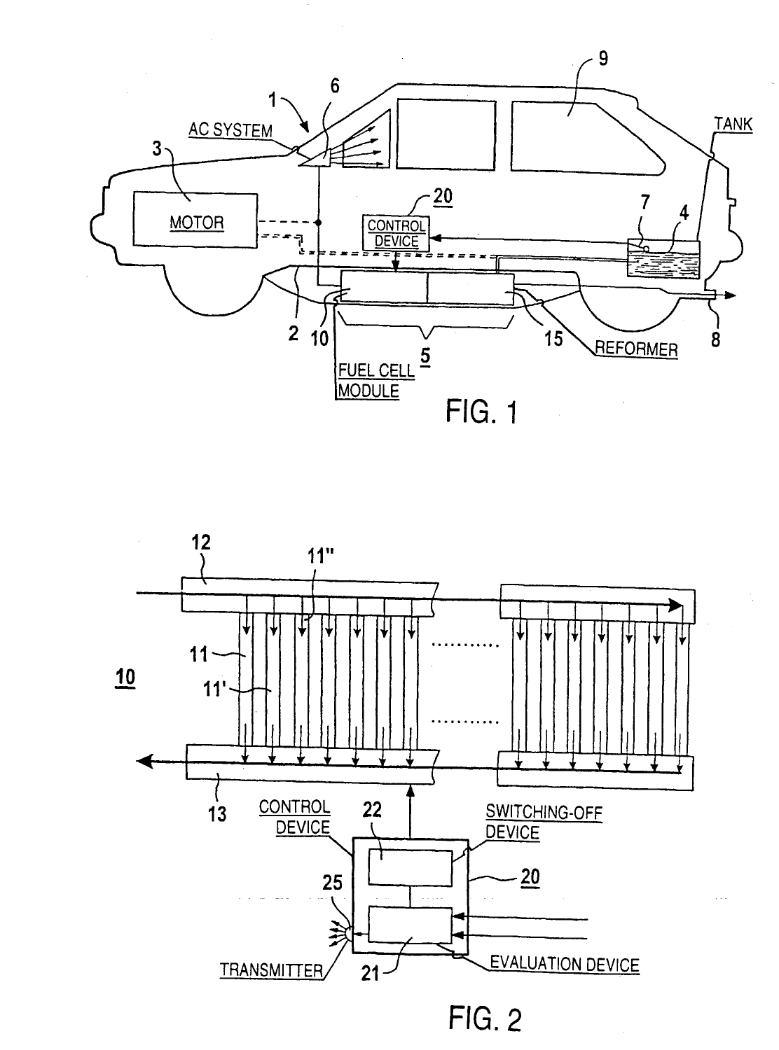

Referring now to the figures of the drawing in detail and first, particularly, to FIG. 1 thereof, there is shown a motor vehicle (Kfz) designed by 1. The illustrated motor vehicle 1 is intended to be especially suitable for a fuel cell drive. In particular, a rotary motor is designated by the numeral 3, an associated fuel cell system by 5 and a tank for liquid or gaseous fuel by 4. The actual fuel cell system 5 is suitably arranged under the floor 2 of the vehicle 1 or in an intermediate floor and is thus accessible from outside. If liquid fuel is stored in the tank 4, a reformer 15 for generating reformer gas is assigned to the fuel cell system 5 using at least one fuel cell module or fuel cell stack 10. The reformer 15 is not represented in detail in FIG. 1.

Instead of the specific fuel cell drive, the vehicle 1 can also be a motor vehicle that is driven conventionally with liquid or gaseous fuel by an internal combustion engine, but the motor vehicle 1 additionally has a fuel cell system 5 that is used in this case exclusively to supply further stationary-vehicle current loads.

In FIG. 1, the fuel system 5 defines a stationary-vehicle current generator for the electric motor 2 of the fuel-cell-operated motor vehicle 1. In the motor vehicle 1, there are also stationary-vehicle current loads such as, in particular, an air-conditioning system 6 for the interior 9 of the vehicle. In such air-conditioning systems 6 that are operated with fuel cells it is particularly advantageous for the air-conditioning systems 6 to operate independently of running the engine and to be supplied directly by the fuel cell. However, with such systems it is necessary to ensure that there is a sufficient supply of fuel for operating the stationary-vehicle current apparatuses and also for operating the driving mode of the motor vehicle, either with a fuel-cell-operated electric drive or an internal combustion engine that is supplied with fuel. A measuring device 7 for the contents of the tank 4 is provided that operates sufficiently precisely and whose signal is available for activating a switching-off device 20.

FIG. 2 is a schematic illustration of the fuel cell stack 10 of the fuel cell system shown in FIG. 1. The fuel cell stack 10 has a multiplicity of fuel cells 11, 11′, . . . , which form the fuel cell stack. According to FIG. 1, the fuel cell stack 10 is assigned to the control device 20 having an evaluation device 21, and a switching-off device 22. The control device 20 has the function of switching off, at a suitable time, the stationary-vehicle apparatuses, i.e. the fuel cell system 5 serving as a stationary-vehicle current generator and the air-conditioning system 6 serving as a stationary-vehicle current load (See FIG. 1). For this purpose, the control device 20 is assigned inputs, one input of which is specifically connected to a filling level signal of the measuring device 7 (FIG. 1) for measuring the fuel level in the tank 4.

Thus, suitable information on the respective contents of the tank are present for a microprocessor-controlled evaluation of data. If the contents of the tank drop below a specific value, for example, 10% of the maximum filling level, a signal with which the fuel cell module 10 is automatically switched off, is generated by the device 20.

It has become apparent that for practical operation, filling levels between 2 and 20%, and in particular between 5 and 15%, should be sensed. A specific value for switching off the stationary-vehicle apparatuses can be selected as a function of the specific prevailing conditions.

The essential feature of the described equipment is that the operator be informed of the state of the stationary-vehicle current apparatuses, in particular of the fuel cell system 5. For this purpose, in the motor vehicle 1 there is at least one display with which the state of the fuel cell system is indicated to the operator of the vehicle before he leaves the vehicle. This can be a signal for a communications network, but can also be an acoustic signal or some other suitable signal. This signal can be emitted via a transmitter 25, for example.

In particular, it is appropriate to communicate the state of the stationary-vehicle current apparatuses via the communications devices that are usually present in the vehicle. For example, the information can be passed on in a wire-free fashion to the lock system of the motor vehicle 1. It is also possible to feed the information into existing communications networks, for example, the telematic system that is known for motor vehicles, and to call into it, for example, using a mobile phone. For this purpose, the control device 20, which usually evaluates further information in addition to the information relating to the contents of the tank, must be connected to a transmitter 25. The operator of the vehicle or else even some other entity can be informed of the current state via the transmitter 25.

In the abovementioned refinement, the stationary-vehicle current apparatus is a fuel cell, a fuel cell module, and/or a fuel cell system. This can be a fuel cell or fuel cell module with or without a reformer. However, it is possible, but not absolutely necessary for the vehicle 1 to be an electric vehicle with a fuel cell drive.

The fuel varies depending on the stationary-vehicle apparatus and/or vehicle, and when the fuel is hydrogen it is accommodated in a storage cylinder rather than in a tank, for which reason the term “tank” may also mean a storage cylinder.

A stationary-vehicle current apparatus is referred to as being activated, for example, if it is switched automatically on and off at a specific time using a timer function. The same applies to activation using a temperature function.

A minimum tank filling level is generally input into the system as the predefined value. The threshold for the device 22 for switching off the stationary-vehicle current apparatus is 2 to 20%, preferably 5 to 15%, in particular approximately 10% of the total, i.e. the completely filled, contents of the tank 4. In particular, depending on the consumption of the motor vehicle 1, the value should be configured in such a way that the contents of the tank 4 are sufficient for the motor vehicle 1 to be started and to be able to operate in a radius of approximately 50 km. If the device 22 for switching off the apparatuses keeps to a specific sequence, a plurality of values can be input at which a switching-off operation takes place.

According to one advantageous refinement, the measuring device 7 and/or the switching-off device 22 can communicate with a predefined entity so that, for example, the operator of the vehicle receives a message by e-mail or by SMS (Short Message Service) on his mobile phone or via an existing car telephone before the stationary-vehicle current apparatus is switched off and/or when a predefined tank filling level is reached. For this purpose, the control device 20 is connected to a communications network so that even a remote interrogation as to whether or not the stationary-vehicle current apparatus is running and as to the level of the contents of the tank 4 is also made possible. In particular, for this purpose it is possible to use the already mentioned telematic system in which a communications network, which is operated by the manufacturer of the vehicle, monitors the state and location of the vehicle using a GPS (Global Positioning System).

It is also possible to issue a prewarning using the control device 20 when there is a specific level of fuel consumption per time unit, and/or when there is a specific tank filling level. Here, it is possible for the driver or keeper of the vehicle to intervene into the switching-off process via the communications system. The automatic switching off then occurs only if the inquiry to the predefined location remains unanswered in a specific time period. In the case of a plurality of switch-off steps and/or prewarnings, the last switch-off stage can be such that all the stationary-vehicle current apparatuses that are not required to start the vehicle are switched off. The on-board and/or stationary-vehicle current supply is advantageously maintained as long as possible in such a case.

The case in which emergency functions are maintained despite the automatic switching-off operation is similar. This includes, for example, a possible anti-frost heater insofar as it is necessary to start a fuel cell module.

If a plurality of different types of stationary-vehicle apparatuses are present, the switching-off device 22 can advantageously be programmed in such a way that the apparatuses are switched off in a specific sequence. This sequence can either be programmed in advance by the driver, or it can be predefined by the manufacturer in accordance with the consumption of current or a similar parameter. It is appropriate here if first the apparatuses with a high level of current consumption are switched off. Finally, the entire stationary-vehicle power supply is switched off, while emergency functions and/or the on-board power supply is maintained.

All types of stationary-vehicle current loads such as heaters, air-conditioning systems of a vehicle, radio, television, icebox, mailbox, Internet connection, and similar devices are referred to as stationary-vehicle current apparatuses. Additionally, stationary-vehicle current generators that run independently of the motor, such as, a rechargeable battery, an accumulator battery, and/or a fuel cell system are also referred to as stationary-vehicle current apparatuses.

The term “tank” is used here not only to refer to a conventional fuel tank such as a petrol tank, but also is used generally for the container in which the fuel is stored and carried. Thus, for example, a hydrogen storage cylinder may also be meant by the term, “tank”.

The measuring device for determining the contents of the tank may be the normal petrol measuring device for the vehicle or a measuring device that is independent of it, in particular, a more precise measuring device.

The device 22 for switching off the stationary-vehicle current apparatus may be a simple switch that interrupts the electrical line and/or the fuel line.

The stationary-vehicle current apparatuses consume fuel during operation. With the invention, the operators of a vehicle are protected against the unpleasant surprise that a running stationary-vehicle current apparatus completely empties the tank. For this purpose, a device 22 for switching off at least one stationary-vehicle current apparatus is connected to a measuring device 7 for determining the contents of the tank 4.

We claim:

1. A configuration, comprising:
a tank for storing fuel;
at least one stationary-vehicle current apparatus directly or indirectly requiring the fuel from said tank;
a switching device for switching off said stationary-vehicle current apparatus; and
a measuring device for determining an amount of the fuel in said tank;
said switching device being automatically activated by information relating to the amount of the fuel in said tank when a predefined value is reached.

2. The configuration according to claim 1, wherein said stationary-vehicle current apparatus is a stationary-vehicle current generator or a stationary-vehicle current load.

3. The configuration according to claim 2, wherein said stationary-vehicle current apparatus is a fuel cell system and/or a fuel cell module with or without a reformer.

4. The configuration according to claim 1, comprising a device for indicating, to an operator of a vehicle before the operator leaves the vehicle, that said stationary-vehicle current apparatus is running and/or activated.

5. The configuration according to claim 4, wherein said device includes a communications network.

6. The configuration according to claim 1, comprising a display for indicating, to an operator of a vehicle before the operator leaves the vehicle, that said stationary-vehicle current apparatus is running and/or activated.

7. The configuration according to claim 1, wherein the predefined value is between 2 and 20% of the amount of the fuel in said tank.

8. The configuration according to claim 1, wherein the predefined value is between 5 and 15% of the amount of the fuel in said tank.

9. The configuration according to claim 1, wherein said tank is a storage cylinder.

10. A method for switching off at least one stationary-vehicle current apparatus, the method which comprises providing a device for switching off the stationary-vehicle current apparatus as a function of contents of a tank.

11. The method according to claim 10, which comprises informing a predefined entity before performing a switching-off operation with the device.

12. The method according to claim 10, which comprises:
performing the step of switching off the stationary-vehicle current apparatus in a plurality of steps; and
finally switching off a stationary-vehicle and/or an on-board power supply while preserving emergency functions.

13. The method according to claim 12, which comprises performing the step of switching off the stationary-vehicle current apparatus after making an inquiry to a predefined entity.

14. The method according to claim 14, wherein the predefined entity is a driver and/or a keeper of the vehicle.
